(19) United States
(12) Patent Application Publication
(10) Pub. No.: US 2023/0008473 A1
(43) Pub. Date: Jan. 12, 2023

(54) VIDEO REPAIRING METHODS, APPARATUS, DEVICE, MEDIUM AND PRODUCTS

(71) Applicant: Beijing Baidu Netcom Science Technology Co., Ltd., Beijing (CN)

(72) Inventors: Xin LI, Beijing (CN); He ZHENG, Beijing (CN); Fanglong LIU, Beijing (CN); Dongliang HE, Beijing (CN)

(21) Appl. No.: 17/944,745

(22) Filed: Sep. 14, 2022

Related U.S. Application Data
(63) Continuation of application No. PCT/CN2022/075035, filed on Jan. 29, 2022.

(30) Foreign Application Priority Data
Jun. 28, 2021 (CN) 202110717424.X

(51) Int. Cl. H04N 19/159; H04N 19/182; G06V 20/40

(52) U.S. Cl. CPC H04N 19/159; G06V 20/46; H04N 19/182

(57) ABSTRACT

A video repairing method, apparatus, device, medium, and product are provided. The method includes: acquiring a to-be-repaired video frame sequence; determining a target category corresponding to each pixel in the to-be-repaired video frame sequence based on the to-be-repaired video frame sequence and a preset category detection model; determining, from the to-be-repaired video frame sequence, to-be-repaired pixels each with a target category being a to-be-repaired category; and performing repairing on to-be-repaired areas corresponding to the to-be-repaired pixels to obtain a target video frame sequence.

### CROSS-REFERENCE TO RELATED APPLICATIONS

The present application is a continuation of International Application No. PCT/CN2022/075035, filed on Jan. 29, 2022, which claims the priority of Chinese Patent Application No. 202110717424.X, titled “VIDEO REPAIRING METHODS, APPARATUS, DEVICE, MEDIUM AND PRODUCTS”, filed on Jun. 28, 2021, the full text of which is incorporated herein by reference. Both of the aforementioned applications are hereby incorporated by reference in their entireties.

### TECHNICAL FIELD

The present disclosure relates to the field of artificial intelligence, and more particularly, to computer vision and deep learning techniques, which can be used in image repairing scenarios.

### BACKGROUND

At present, old films are usually filmed and archived by films. Therefore, old film storage imposes a high requirement on a storage environment.

However, actual storage environment is difficult to achieve an ideal storage condition, and therefore, problems such as scratches, dirty spots, noise, and the like may occur in old films. These problems need to be fixed in order to ensure a clarity of an old film when being played. In existing repairing methods, areas in question are manually labeled frame-by-frame by an experienced technician, and then repaired. However, manual repair has a problem of a low efficiency.

### SUMMARY

The present disclosure provides a video repairing method, apparatus, device, medium, and product.

Some embodiments of the present disclosure provide a video repairing method, including: acquiring a to-be-repaired video frame sequence; determining a target category corresponding to each pixel in the to-be-repaired video frame sequence based on the to-be-repaired video frame sequence and a preset category detection model; determining, from the to-be-repaired video frame sequence, to-be-repaired pixels each with a target category being a to-be-repaired category; and performing repairing on to-be-repaired areas corresponding to the to-be-repaired pixels to obtain a target video frame sequence.

Some embodiments of the present disclosure provide a video repairing apparatus, including a video acquiring unit configured to acquire a to-be-repaired video frame sequence; a category determining unit configured to determine a target category corresponding to each pixel in the to-be-repaired video frame sequence based on the to-be-repaired video frame sequence and a preset category detection model; a pixel determining unit configured to determine, from the to-be-repaired video frame sequence, to-be-repaired pixels each with a target category being a to-be-repaired category; and a video repairing unit configured to perform repairing on to-be-repaired areas corresponding to the to-be-repaired pixels to obtain a target video frame sequence.

Some embodiments of the present disclosure provide an electronic device including: at least one processor; and a memory communicatively connected to the at least one processor; where the memory stores instructions executable by the at least one processor, and the instructions are executed by the at least one processor, such that the at least one processor can execute a video repairing method as described above.

Some embodiments of the present disclosure provide a non-transitory computer readable storage medium storing computer instructions, where the computer instructions are used for causing a computer to execute a video repairing method as described above.

Some embodiments of the present disclosure provide a computer program product including a computer program, where the computer program, when executed by a processor, implements a video repairing method as described above.

It is to be understood that the description in this section is not intended to identify key or critical features of the embodiments of the disclosure, nor is it intended to limit the scope of the disclosure. Other features of the present disclosure will become readily apparent from the following description.

### BRIEF DESCRIPTION OF THE DRAWINGS

The drawings are for a better understanding of the present invention and do not constitute a limitation of the present disclosure, where:

FIG. 1 is an exemplary system architecture diagram in which an embodiment of the present disclosure may be applied;

FIG. 2 is a flowchart of a video repairing method according to of an embodiment the present disclosure;

FIG. 3 is a schematic diagram of an application scenario of a video repairing method according to the present disclosure;

FIG. 4 is a flowchart of a video repairing method according to another embodiment of the present disclosure;

FIG. 5 is a schematic structural diagram of a video repairing apparatus according an embodiment of to the present disclosure; and

FIG. 6 is a block diagram of an electronic device used to implement a video repairing method of an embodiment of the present disclosure.

### DETAILED DESCRIPTION OF EMBODIMENTS

The following description of exemplary embodiments of the present disclosure, taken in conjunction with the accompanying drawings, includes various details of embodiments of the present disclosure to facilitate understanding, and is to be considered as exemplary only. Accordingly, one of ordinary skill in the art will recognize that various changes and modifications may be made to the embodiments described herein without departing from the scope and spirit of the disclosure. Also, for clarity and conciseness, descriptions of well-known functions and structures are omitted from the following description.

It is noted that the embodiments in the present disclosure and the features in the embodiments may be combined with each other without conflict. The present disclosure will now be described in detail with reference to the accompanying drawings and examples.

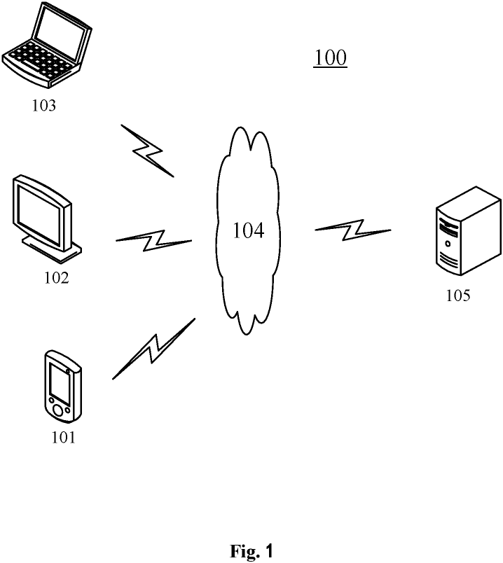

As shown in FIG. 1, the system architecture 100 may include terminal devices 101, 102, 103, a network 104, and a server 105. The network 104 serves as a medium for providing a communication link between the terminal devices 101, 102, 103 and the server 105. Network 104 may include various types of connections, such as wired, wireless communication links, or fiber optic cables, among others.

The user may interact with the server 105 through the network 104 using the terminal devices 101, 102, 103 to receive or send messages, etc. The terminal devices 101, 102, and 103 may be electronic devices such as a mobile phone, a computer, and a tablet. The terminal devices 101, 102, and 103 include software for repairing a video. A user may input a video to be repaired, such as a video of an old film, into the software for repairing the video. The software may output the repaired video, such as an old film after repaired.

The terminal devices 101, 102, 103 may be hardware or software. When the terminal devices 101, 102, 103 are hardware, various electronic devices may be used, including but not limited to a television, a smartphone, a tablet computer, an electronic book reader, an in-vehicle computer, a laptop computer, a desktop computer, and the like. When the terminal devices 101, 102, and 103 are software, they may be installed in the electronic devices listed above. It may be implemented as a plurality of software or software modules (e.g., for providing distributed services) or as a single software or software module. It is not specifically limited herein.

The server 105 may be a server providing various services. For example, after the terminal devices 101, 102, and 103 acquire the to-be-repaired video frame sequence input by the user, the server 105 may input the to-be-repaired video frame sequence into a preset category detection model to obtain a target category corresponding to each pixel in the to-be-repaired video frame sequence, and determine pixels each with a target category being a to-be-repaired category as to-be-repaired pixels. The target video frame sequence, that is, the repaired video, can be obtained by repairing areas corresponding to to-be-repaired pixels, and the target video frame sequence is transmitted to the terminal devices 101, 102, and 103.

It should be noted that the server 105 may be hardware or software. When the server 105 is hardware, it may be implemented as a distributed server cluster of multiple servers, or it may be implemented as a single server. When the server 105 is software, it may be implemented as a plurality of software or software modules (e.g., for providing distributed services), or it may be implemented as a single software or software module. It is not specifically limited herein.

It should be noted that the video repairing method provided in the embodiments of the present disclosure may be executed by the terminal devices 101, 102, 103, or may be executed by the server 105. Accordingly, the video repairing apparatus may be provided in the terminal devices 101, 102, 103 or in the server 105.

It should be understood that the number of terminal devices, networks and servers in FIG. 1 is merely illustrative. There may be any number of terminal devices, networks, and servers as desired for implementation.

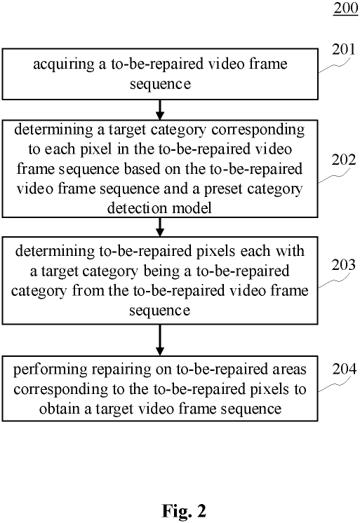

With continuing reference to FIG. 2, a flow 200 of a video repairing method in accordance with an embodiment of the present disclosure is shown. The video repairing method of the present embodiment includes the step 201 to 204.

Step 201: acquiring a to-be-repaired video frame sequence.

In the present embodiment, an execution body (the server 105 or the terminal devices 101, 102, and 103 in FIG. 1) may acquire the to-be-repaired video frame sequence from the locally stored data, may acquire the to-be-repaired video frame sequence from other connected electronic devices, or may acquire the to-be-repaired video frame sequence from a network, which is not limited in the present embodiment. The to-be-repaired video frame sequence refers to a sequence of video frames included in a to-be-repaired target video. Optionally, when the execution body acquires the to-be-repaired video frame sequence, the execution body may first perform preliminary screening on the video frames included in the to-be-repaired target video, and determine that there is at least one video frame required to be repaired, so as to constitute the to-be-repaired video frame sequence by the at least one video frame. For example, image recognition is performed on each video frame included in the target video. A video frame is determined as a candidate video frame in response to determining that there is a to-be-repaired object in the video frame, and the to-be-repaired video frame sequence is generated based on the determined candidate video frame(s). The image recognition herein may employ an existing image recognition technique for recognizing a to-be-repaired object, such as a scratch, noise, in an image.

Step 202: determining a target category corresponding to each pixel in the to-be-repaired video frame sequence based on the to-be-repaired video frame sequence and a preset category detection model.

In this embodiment, the preset category detection model is used to detect whether a pixel in a to-be-repaired video frame of the to-be-repaired video frame sequence is a to-be-repaired pixel. The to-be-repaired pixel refers to a pixel corresponding to a to-be-repaired object in a video frame, and the to-be-repaired object may include but is not limited to a scratch, a noise spot, a noise point, and the like, which is not limited in this embodiment. In order to detect whether a pixel is a to-be-repaired pixel, output data of the preset category detection model may be a probability that the pixel is a to-be-repaired pixel, a probability that the pixel is not a to-be-repaired pixel, a probability that the pixel is a normal pixel, a probability that the pixel is not a normal pixel, and the like. This embodiment is not limited thereto. For adjustment of a form of the output data, a corresponding configuration can be made at a training stage of the category detection model. After acquiring the output data outputted by the preset category detection model based on the to-be-repaired video frame sequence, the execution body may analyze the output data and determine the target category corresponding to each pixel in the to-be-repaired video frame sequence. The target category includes a category that needs to be repaired, such as a to-be-repaired category, and may also include a category that does not need to be repaired, such as a normal category. Optionally, the target category may also include a pending category, i.e., a category that is difficult to accurately determine based on the output data. For such a pending category, a relevant pixel can be output after being labeled, so that relevant personnel can make a decision manually on the pixel, thereby improving an accuracy of determining a to-be-repaired area.

In some optional implementations of the present embodiment, the target category includes a to-be-repaired category and a normal category. Further, determining a target category corresponding to each pixel in the to-be-repaired video frame sequence based on the to-be-repaired video frame sequence and the preset category detection model includes: inputting the to-be-repaired video frame sequence into the preset category detection model to obtain a probability graph of each to-be-repaired video frame in the to-be-repaired video frame sequence output by the preset category detection model. A probability graph is used for indicating a probability that a pixel in a to-be-repaired video frame belongs to a to-be-repaired category. The target category corresponding to each pixel in the to-be-repaired video frame sequence is determined based on the probability graph and a preset probability threshold.

In the present implementation, the to-be-repaired category refers to a category that needs to be repaired, and the normal category refers to a category that does not need to be repaired. The execution body determines the target category corresponding to each pixel in the to-be-repaired video frame sequence based on the to-be-repaired video frame sequence and the preset category detection model, and specifically, inputs the to-be-repaired video frame sequence into the preset category detection model to obtain the probability graph output by the preset category detection model. Each to-be-repaired video frame may correspond to a probability graph that represents probabilities, each of which indicates that a pixel in the corresponding to-be-repaired video frame belongs to the to-be-repaired category. The execution body may set a preset probability threshold in advance, and may determine that each pixel belongs to the to-be-repaired category or the normal category by comparing the probability that the pixel belongs to the to-be-repaired category with the preset probability threshold. For example, for a probability that a pixel belongs to the to-be-repaired category, in response to determining that the probability is greater than the preset probability threshold, it is determined that the pixel belongs to the to-be-repaired category; and in response to determining that the probability is less than or equal to the preset probability threshold, it is determined that the pixel belongs to a normal class.

Step 203, determining to-be-repaired pixels each with a target category being a to-be-repaired category from the to-be-repaired video frame sequence.

In the present embodiment, the execution body may determine the pixels each with a target category being the to-be-repaired category as the to-be-repaired pixels. The execution body may also remove pixels each with a target category being the normal from all pixels, and determine the remaining pixels as to-be-repaired pixels.

Step 204: performing repairing on to-be-repaired areas corresponding to the to-be-repaired pixels to obtain a target video frame sequence.

In the present embodiment, the execution body may determine the to-be-repaired areas based on the to-be-repaired pixels, the to-be-repaired areas being composed of the to-be-repaired pixels. The target video frame sequence can be obtained by repairing the to-be-repaired areas. The repairing herein may employ existing repairing techniques, such as by repairing the to-be-repaired areas based on various existing video repairing software to obtain the target video frame sequence.

With continuing reference to FIG. 3, a schematic diagram of an application scenario of a video repairing method according to the present disclosure is shown. In the application scenario of FIG. 3, the execution body may acquire a to-be-repaired old film 301, input the to-be-repaired old film 301 into a category detection model 302, obtain probability information, output from the category detection model 302, of each pixel being a pixel corresponding to a scratch in each video frame of the old film 301, and determine a pixel category 303 of each pixel based on the probability information. The pixel category 303 is a category corresponding to a scratch and a category corresponding to a non-scratch. The execution body use all pixels each with the pixel category 303 being the category corresponding to the scratch to constitute the scratch areas 304. Then, the scratch areas 304 are input to a specified repair software and are repaired to obtain the repaired old film 305.

According to the video repairing method provided in the above embodiment of the present disclosure, a target category corresponding to each pixel in a to-be-repaired video frame sequence can be automatically determined by using a category detection model, a to-be-repaired pixel that needs to be repaired is determined based on the target category, and repairing is performed on to-be-repaired areas corresponding to the to-be-repaired pixels, thereby realizing automatic repair of a video and improving the video repair efficiency.

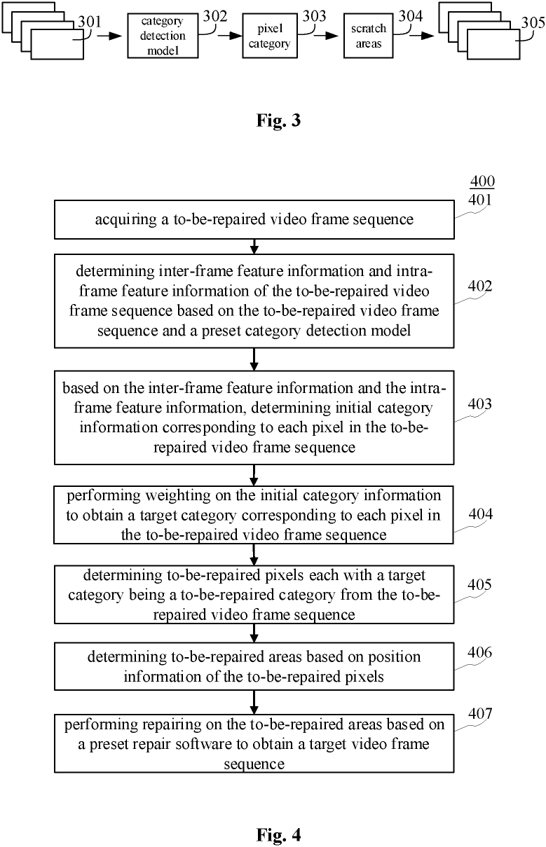

With continuing reference to FIG. 4, there is shown a flow 400 of a video repairing method according to another embodiment of the present disclosure. As shown in FIG. 4, the video repairing method of the present embodiment may include the following step 401 to 407.

Step 401: acquiring a to-be-repaired video frame sequence.

In the present embodiment, for a detailed description of step 401, reference is made to the detailed description of step 201, and details are not described herein.

Step 402: determining inter-frame feature information and intra-frame feature information of the to-be-repaired video frame sequence based on the to-be-repaired video frame sequence and a preset category detection model.

In the present embodiment, the execution body may input the to-be-repaired video frame sequence into the preset category detection model to enable the category detection model to extract the inter-frame feature information and the intra-frame feature information of the to-be-repaired video frame sequence. The inter-frame feature information refers to associated image features between adjacent video frames, and the intra-frame feature information refers to image features of each video frame. Optionally, the category detection model may include a timing convolution network module. After the to-be-repaired video frame sequence is input to the category detection model, the to-be-repaired video frame sequence may first pass through the timing convolution network module to determine a timing feature between two video frames, that is, to determine the inter-frame feature information. Then the intra-frame feature information is obtained based on the image features of each to-be-repaired video frame in the to-be-repaired video frame sequence. The sequential convolution network module may consist of a three-dimensional convolution layer or the like.

In some optional implementations of the present embodiment, the preset category detection model is trained by the following steps: obtaining a sample video frame sequence and sample labeling information, the sample labeling information being used to label a category of each sample pixel in the sample video frame sequence; determining a sample inter-frame feature and a sample intra-frame feature of sample video frame sequence based on the sample video frame sequence and a to-be-trained model; determining initial sample category information for each sample pixel in the sample video frame sequence based on the sample inter-frame feature and the sample intra-frame feature; performing weighting on the initial sample category information to obtain a sample target category corresponding to each sample pixel in the sample video frame sequence; and adjusting parameters of the to-be-trained model based on the sample target category and the sample labeling information until the to-be-trained model converges, so as to obtain the trained preset category detection model.

In the present embodiment, the execution body may use the pre-repair video frame sequence of the repaired video as the sample video frame sequence, and compare the pre-repair video frame sequence with the repaired video frame sequence to obtain the sample labeling information. In this manner, the sample video frame sequence and the sample labeling information are determined without manual labeling, and a model training efficiency is higher. The sample labeling information may only be obtained for to-be-repaired sample pixels, and the sample pixels remained unlabeled are sample pixels that do not need to be repaired. In the sample pixels, it is possible to label only the sample pixels that do not need to be repaired, and the remaining sample pixels that are labeled are the sample pixels that need to be repaired. Further, the execution body inputs the sample video frame sequence into the to-be-trained model so that the to-be-trained model determines a sample inter-frame feature and a sample intra-frame feature. The manner of determining the sample inter-frame feature and the sample intra-frame feature is similar to the manner of determining the inter-frame feature information and the intra-frame feature information, and details are not described herein.

Thereafter, the execution body may use the sample inter-frame feature and the sample intra-frame feature as input data of a cyclic convolution neural module of the to-be-trained model, so that the cyclic convolution neural module performs feature analysis on the sample inter-frame feature and the sample intra-frame feature, and obtains initial sample category information of each sample pixel. The initial sample category information is used to indicate whether each sample pixel belongs to a to-be-repaired category or not, and a specific representation thereof may be a probability that each sample pixel belongs to the to-be-repaired category, a probability that each sample pixel does not belong to the to-be-repaired category, a probability that each sample pixel belongs to a normal category, a probability that each sample pixel does not belong to the normal category, or the like, which is not limited thereto. Furthermore, the cyclic convolution neural module may be composed of a multilayer convLSTM (a combination of a convolution neural network and a long-term and short-term memory network) or a multilayer convGRU (a combination of a convolution neural network and a gated cyclic unit).

Thereafter, the execution body may input the initial sample category information to an attention module of the to-be-trained model, so that the attention module performs weighting on the initial sample category information to obtain a sample target category corresponding to each sample pixel in the sample video frame sequence. Specifically, the execution body may use the attention module to multiply a probability corresponding to each sample pixel in the initial sample category information by a corresponding weighting weight, and compare the weighted probability with a preset threshold to obtain a sample target category corresponding to each sample pixel. For example, if a weighted probability of a sample pixel belonging to the to-be-repaired category is greater than the preset threshold, it is determined that the sample pixel belongs to the to-be-repaired category. The output data of the to-be-trained model herein may be the weighted probability that a sample pixel is the to-be-repaired sample pixel, the weighted probability that the sample pixel is not the to-be-repaired sample pixel, the weighted probability that the sample pixel is the normal sample pixel, and the weighted probability that the sample pixel is not the normal sample pixel. The sample target category corresponding to each sample pixel is determined based on output data of the to-be-trained model, and parameters of the to-be-trained model are adjusted based on the sample target category and the sample labeling information until the model converges, thereby realizing training of the category detection model. Optionally, the output data of the to-be-trained model may be a probability graph obtained by weighting probability data by the attention module, and then inputting the weighted probability data to an upsampling convolution module. The upsampling convolution module is configured to restore a resolution of a feature map corresponding to the probability data to a resolution of the sample video frame.

In other optional implementations of the present embodiment, determining initial sample category information of each sample pixel in a sample video frame sequence based on the sample inter-frame feature and the sample intra-frame feature includes: performing a convolution operation on the sample inter-frame feature and the sample intra-frame feature to obtain a sample convolution feature; and based on the sample convolution feature, determining the initial sample category information for each sample pixel in the sample video frame sequence.

In the present implementation, after obtaining the sample inter-frame feature and the sample intra-frame feature, the execution body may perform the convolution operation, such as a two-dimensional convolution operation, on the sample inter-frame feature and the sample intra-frame feature to obtain the sample convolution feature, and determine the initial sample category information based on the sample convolution feature. This process can reduce a feature resolution using the convolution operation, and can improve a model training speed.

Step 403: based on the inter-frame feature information and the intra-frame feature information, determining initial category information corresponding to each pixel in the to-be-repaired video frame sequence.

In the present embodiment, in an application stage of the category detection model, based on the same principle as that of the training stage, the execution body can input the acquired inter-frame feature information and intra-frame feature information into a cyclic convolution neural module of the category detection model, so that the cyclic convolution neural module outputs the initial category information. For a detailed description of the initial category information, reference can be made to the detailed description of the initial sample category information, which will not be described herein. For the detailed description of determining the initial category information corresponding to each pixel in the to-be-repaired video frame sequence based on the inter-frame feature information and the intra-frame feature information, reference can be made to the detailed description of determining the initial sample category information of each sample pixel in the sample video frame sequence based on the sample inter-frame feature and the sample intra-frame feature, which will not be described herein.

In some optional implementations of the present embodiment, determining the initial category information corresponding to each pixel in the to-be-repaired video frame sequence based on the inter-frame feature information and the intra-frame feature information, including: performing a convolution operation on the inter-frame feature information and the intra-frame feature information to obtain feature information after the convolution operation; and determining the initial category information corresponding to each pixel in the to-be-repaired video frame sequence based on the feature information after the convolution operation.

In the present implementation, the detailed description of the above steps can refer to the detailed description of performing the convolutional operation on the sample inter-frame feature and the sample intra-frame feature to obtain the sample convolutional feature and based on the sample convolutional feature, determining the the sample initial category information of each sample pixel in the sample video frame sequence, which will not be described herein. The resolution of the inter-frame feature information and the intra-frame feature information can be reduced by means of the convolution operation, and a determination speed of the initial category information can be improved.

Step 404: performing weighting on the initial category information to obtain a target category corresponding to each pixel in the to-be-repaired video frame sequence.

In the present embodiment, the detailed description of step 404 can refer to the detailed description of weighting the initial sample category information to obtain the sample target category corresponding to each sample pixel in the sample video frame sequence, which will not be described herein.

Step 405, determining to-be-repaired pixels each with a target category being a to-be-repaired category from the to-be-repaired video frame sequence.

In the present embodiment, for the detailed description of step 405, reference is made to the detailed description of step 203, which will not be described herein.

Step 406: determining to-be-repaired areas based on position information of the to-be-repaired pixels.

In the present embodiment, the execution body can acquire position coordinates of the to-be-repaired pixels, and determine the to-be-repaired areas based on areas each surrounded by the position coordinates.

Step 407: performing repairing on the to-be-repaired areas based on a preset repair software to obtain a target video frame sequence.

In the present embodiment, the preset repairing software may be various existing software for repairing the to-be-repaired area. The execution body may label the to-be-repaired areas in the to-be-repaired video frame sequence, and import the labeled to-be-repaired video frame sequence to the preset repairing software, so that the preset repairing software performs repairing on the to-be-repaired areas to obtain the target video frame sequence.

According to the video repairing method provided in the above embodiment of the present disclosure, it is also possible to determine a category of a pixel based on the inter-frame feature information and the intra-frame feature information of the to-be-repaired video frame sequence, thereby improving a category determination accuracy of the pixels. Further, it is also possible to obtain the initial category information first, and then perform weighting on the initial category information to obtain the target category, so that an accuracy of determining the category information can be further improved. Moreover, the to-be-repaired areas are determined based on the position information of the to-be-repaired pixels, and repairing is performed by using the preset repair software, so that automatic video repair can be realized, and the video repair efficiency is improved.

With further reference to FIG. 5, as an implementation of the method shown in each of the above figures, the present disclosure provides an embodiment of a video repairing apparatus, which corresponds to the method embodiment shown in FIG. 2, and which can be specifically applied to various servers or terminal devices.

As shown in FIG. 5, the video repairing apparatus 500 in the present embodiment includes a video acquiring unit 501, a category determining unit 502, a pixel determining unit 503, and a video repairing unit 504.

The video acquiring unit 501 is configured to acquire a to-be-repaired video frame sequence.

The category determining unit 502 is configured to determine a target category corresponding to each pixel in the to-be-repaired video frame sequence based on the to-be-repaired video frame sequence and a preset category detection model.

A pixel determining unit 503 configured to determine, from the to-be-repaired video frame sequence, to-be-repaired pixels each with a target category being a to-be-repaired category.

The video repairing unit 504 is configured to perform repairing on to-be-repaired areas corresponding to the to-be-repaired pixels to obtain a target video frame sequence.

In some optional implementations of the present embodiment, the category determining unit 502 is further configured to determine inter-frame feature information and intra-frame feature information of the to-be-repaired video frame sequence based on the to-be-repaired video frame sequence and the preset category detection model; determine initial category information corresponding to each pixel in the to-be-repaired video frame sequence based on the inter-frame feature information and the intra-frame feature information; and perform weighting on the initial category information to obtain the target category corresponding to each pixel in the to-be-repaired video frame sequence.

In some optional implementations of the present embodiment, the category determining unit 502 is further configured to perform a convolution operation on the inter-frame feature information and the intra-frame feature information to obtain feature information after the convolution operation; and determin the initial category information corresponding to each pixel in the to-be-repaired video frame sequence based on the feature information after the convolution operation.

In some optional implementations of the present embodiment, the apparatus further comprises a model training unit configured to acquire a sample video frame sequence and sample labeling information, the sample labeling information being used to label a category of each sample pixel in the sample video frame sequence; determine a sample inter-frame feature and a sample intra-frame feature of the sample video frame sequence based on the sample video frame sequence and a to-be-trained model; determine initial sample category information for each sample pixel in the sample video frame sequence based on the sample inter-frame feature and the sample intra-frame feature; perform weighting on the initial sample category information to obtain a sample target category corresponding to each sample pixel in the sample video frame sequence; and adjust parameters of the to-be-trained model based on the sample target category and the sample labeling information until the to-be-trained model converges, so as to obtain the preset category detection model after training.

In some optional implementations of the present embodiment, the target category comprises the to-be-repaired category and a normal category, the category determining unit 502 is further configured to input the to-be-repaired video frame sequence into the preset category detection model to obtain a probability graph, output by the preset category detection model, of each to-be-repaired video frame in the to-be-repaired video frame sequence, the probability graph being used to represent a probability that each pixel in each to-be-repaired video frame belongs to the to-be-repaired category; and determine the target category corresponding to each pixel in the to-be-repaired video frame sequence based on the probability graph and a preset probability threshold.

In some optional implementations of the present embodiment, the video repairing unit 504 is further configured to determine the to-be-repaired areas based on position information of the to-be-repaired pixels; and perform repairing77 on the to-be-repaired areas based on preset repair software to obtain the target video frame sequence.

It will be appreciated that the units 501 to 504 described in the video repairing apparatus 500 correspond to the respective steps in the method described with reference to FIG. 2. Thus, the operations and features described above with respect to the method of talking on-board a vehicle are equally applicable to the apparatus 500 and the units contained therein, and details are not described herein.

According to an embodiment of the present disclosure, the present disclosure also provides an electronic device, a readable storage medium, and a computer program product.

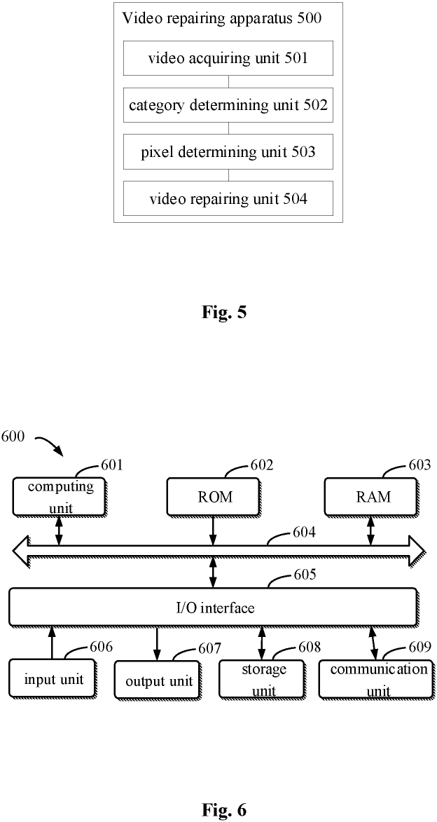

FIG. 6 illustrates a schematic block diagram of an exemplary electronic device 600 that may be used to implement embodiments of the present disclosure. Electronic devices are intended to represent various forms of digital computers, such as laptop computers, desktop computers, worktables, personal digital assistants, servers, blade servers, mainframe computers, and other suitable computers. Electronic devices may also represent various forms of mobile devices, such as personal digital processing, cellular telephones, smart phones, wearable devices, and other similar computing devices. The components shown herein, their connections and relationships, and their functions are by way of example only and are not intended to limit the implementation of the disclosure described and/or claimed herein.

As shown in FIG. 6, the device 600 includes a computing unit 601, which may perform various appropriate actions and processes according to a computer program stored in a read-only memory (ROM) 602 or a computer program loaded into a random access memory (RAM) 603 from a storage unit 608. In RAM 603, various programs and data required for operation of the device 600 may also be stored. The computing units 601, ROM 602 and RAM 603 are connected to each other via a bus 604. An input/output (I/O) interface 605 is also connected to bus 604.

A plurality of components in the device 600 are connected to the I/O interface 605, including an input unit 606, such as a keyboard, a mouse, and the like; an output unit 607, for example, various types of displays, speakers, and the like; a storage unit 608, such as a magnetic disk, an optical disk, or the like; and a communication unit 609, such as a network card, a modem, or a wireless communication transceiver. The communication unit 609 allows the device 600 to exchange information/data with other devices over a computer network such as the Internet and/or various telecommunications networks.

The computing unit 601 may be various general-purpose and/or special-purpose processing components having processing and computing capabilities. Some examples of computing units 601 include, but are not limited to, central processing units (CPUs), graphics processing units (GPUs), various specialized artificial intelligence (AI) computing chips, various computing units that run machine learning model algorithms, digital signal processors (DSPs), and any suitable processors, controllers, microcontrollers, and the like. The computing unit 601 performs various methods and processes described above, such as a method for repairing video. For example, in some embodiments, a video repairing method may be implemented as a computer software program tangibly embodied in a machine-readable medium, such as a storage unit 608. In some embodiments, some or all of the computer program may be loaded and/or installed on the device 600 via the ROM 602 and/or the communication unit 609. When the computer program is loaded into the RAM 603 and executed by the computing unit 601, one or more steps of the video repairing method described above may be performed. Alternatively, in other embodiments, the computing unit 601 may be configured to perform a video repairing method by any other suitable means (e.g., by means of firmware).

The various embodiments of the systems and techniques described above herein may be implemented in a digital electronic circuit system, an integrated circuit system, a field programmable gate array (FPGA), an application specific integrated circuit (ASIC), a special purpose standard product (ASSP), a system on a system on a chip (SOC), a load programmable logic device (CPLD), computer hardware, firmware, software, and/or combinations thereof. These various embodiments may include being implemented in one or more computer programs that may execute and/or interpret on a programmable system including at least one programmable processor, which may be a dedicated or general purpose programmable processor, may receive data and instructions from a memory system, at least one input device, and at least one output device, and transmit the data and instructions to the memory system, the at least one input device, and the at least one output device.

The program code for carrying out the methods of the present disclosure may be written in any combination of one or more programming languages. These program codes may be provided to a processor or controller of a general purpose computer, special purpose computer, or other programmable data processing apparatus such that the program code, when executed by the processor or controller, causes the functions/operations specified in the flowchart and/or block diagram to be implemented. The program code may be executed entirely on the machine, partly on the machine, partly on the machine as a stand-alone software package and partly on the remote machine or entirely on the remote machine or server.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage medium may include one or more line-based electrical connections, portable computer disks, hard disks, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination of the foregoing.

To provide interaction with a user, the systems and techniques described herein may be implemented on a computer having a display device (e.g., a CRT (cathode ray tube) or LCD (liquid crystal display) monitor) for displaying information to the user; And a keyboard and a pointing device (e.g., a mouse or a trackball) through which a user can provide input to a computer. Other types of devices may also be used to provide interaction with a user; For example, the feedback provided to the user may be any form of sensory feedback (e.g., visual feedback, auditory feedback, or tactile feedback); And input from the user may be received in any form, including acoustic input, speech input, or tactile input.

The systems and techniques described herein may be implemented in a computing system including a background component (e.g., as a data server), or a computing system including a middleware component (e.g., an application server), or a computing system including a front-end component (e.g., a user computer having a graphical user interface or a web browser through which a user may interact with embodiments of the systems and techniques described herein), or a computing system including any combination of such background component, middleware component, or front-end component. The components of the system may be interconnected by any form or medium of digital data communication (e.g., a communication network). Examples of communication networks include a local area network (LAN), a wide area network (WAN), and the Internet.

The computer system may include a client and a server. The client and server are typically remote from each other and typically interact through a communication network. The relationship between the client and the server is generated by a computer program running on the corresponding computer and having a client-server relationship with each other. The server may be a cloud server, a server of a distributed system, or a server incorporating a chain of blocks.

It is to be understood that the steps of reordering, adding or deleting may be performed using the various forms shown above. For example, the steps described in the present disclosure may be performed in parallel or sequentially or in a different order, so long as the desired results of the technical solution disclosed in the present disclosure can be realized, and no limitation is imposed herein.

The foregoing detailed description is not intended to limit the scope of the present disclosure. It will be appreciated by those skilled in the art that various modifications, combinations, subcombinations, and substitutions may be made depending on design requirements and other factors. Any modifications, equivalents, and modifications that fall within the spirit and principles of the disclosure are intended to be included within the scope of protection of the disclosure.

What is claimed is:

1. A video repairing method, comprising:
acquiring a to-be-repaired video frame sequence;
determining a target category corresponding to each pixel in the to-be-repaired video frame sequence based on the to-be-repaired video frame sequence and a preset category detection model;
determining, from the to-be-repaired video frame sequence, to-be-repaired pixels each with a target category being a to-be-repaired category; and
performing repairing on to-be-repaired areas corresponding to the to-be-repaired pixels to obtain a target video frame sequence.

2. The method of claim 1, wherein determining a target category corresponding to each pixel in the to-be-repaired video frame sequence based on the to-be-repaired video frame sequence and a preset category detection model comprises:
determining inter-frame feature information and intra-frame feature information of the to-be-repaired video frame sequence based on the to-be-repaired video frame sequence and the preset category detection model;
determining initial category information corresponding to each pixel in the to-be-repaired video frame sequence based on the inter-frame feature information and the intra-frame feature information; and
performing weighting on the initial category information to obtain the target category corresponding to each pixel in the to-be-repaired video frame sequence.

3. The method of claim 2, wherein determining initial category information corresponding to each pixel in the to-be-repaired video frame sequence based on the inter-frame feature information and the intra-frame feature information comprises:
performing a convolution operation on the inter-frame feature information and the intra-frame feature information to obtain feature information after the convolution operation; and
determining the initial category information corresponding to each pixel in the to-be-repaired video frame sequence based on the feature information after the convolution operation.

4. The method according to claim 1, wherein the preset category detection model is trained by:
acquiring a sample video frame sequence and sample labeling information, the sample labeling information being used to label a category of each sample pixel in the sample video frame sequence;
determining a sample inter-frame feature and a sample intra-frame feature of the sample video frame sequence based on the sample video frame sequence and a to-be-trained model;
determining initial sample category information for each sample pixel in the sample video frame sequence based on the sample inter-frame feature and the sample intra-frame feature;
performing weighting on the initial sample category information to obtain a sample target category corresponding to each sample pixel in the sample video frame sequence; and
adjusting parameters of the to-be-trained model based on the sample target category and the sample labeling information until the to-be-trained model converges, so as to obtain the preset category detection model after training.

5. The method of claim 4, wherein determining initial sample category information for each sample pixel in the sample video frame sequence based on the sample inter-frame feature and the sample intra-frame feature comprises:
performing a convolution operation on the sample inter-frame feature and the sample intra-frame feature to obtain a sample convolution feature; and
determining the sample initial category information for each sample pixel in the sample video frame sequence based on the sample convolution feature.

6. The method according to claim 1, wherein the target category comprises the to-be-repaired category and a normal category; and
determining a target category corresponding to each pixel in the to-be-repaired video frame sequence based on the to-be-repaired video frame sequence and a preset category detection model comprises:
inputting the to-be-repaired video frame sequence into the preset category detection model to obtain a probability graph, output by the preset category detection model, of each to-be-repaired video frame in the to-be-repaired video frame sequence, the probability graph being used to represent a probability that each pixel in each to-be-repaired video frame belongs to the to-be-repaired category; and
determining the target category corresponding to each pixel in the to-be-repaired video frame sequence based on the probability graph and a preset probability threshold.

7. The method according to claim 1, wherein the performing repairing on to-be-repaired areas corresponding to the to-be-repaired pixels to obtain a target video frame sequence comprises:
determining the to-be-repaired areas based on position information of the to-be-repaired pixels; and
performing repairing on the to-be-repaired areas based on preset repair software to obtain the target video frame sequence.

8. A video repairing apparatus, comprising:
at least one processor; and
a memory storing instructions, wherein the instructions when executed by the at least one processor, cause the at least one processor to perform operations, the operations comprising:
acquiring a to-be-repaired video frame sequence;
determining a target category corresponding to each pixel in the to-be-repaired video frame sequence based on the to-be-repaired video frame sequence and a preset category detection model;
determining, from the to-be-repaired video frame sequence, to-be-repaired pixels each with a target category being a to-be-repaired category; and
performing repairing on to-be-repaired areas corresponding to the to-be-repaired pixels to obtain a target video frame sequence.

9. The apparatus of claim 8, wherein determining a target category corresponding to each pixel in the to-be-repaired video frame sequence based on the to-be-repaired video frame sequence and a preset category detection model comprises:
determining inter-frame feature information and intra-frame feature information of the to-be-repaired video frame sequence based on the to-be-repaired video frame sequence and the preset category detection model;
determining initial category information corresponding to each pixel in the to-be-repaired video frame sequence based on the inter-frame feature information and the intra-frame feature information; and
performing weighting on the initial category information to obtain the target category corresponding to each pixel in the to-be-repaired video frame sequence.

10. The apparatus of claim 9, wherein determining initial category information corresponding to each pixel in the to-be-repaired video frame sequence based on the inter-frame feature information and the intra-frame feature information comprises:
performing a convolution operation on the inter-frame feature information and the intra-frame feature information to obtain feature information after the convolution operation; and
determining the initial category information corresponding to each pixel in the to-be-repaired video frame sequence based on the feature information after the convolution operation.

11. The apparatus according to claim 8, wherein the preset category detection model is trained by:
acquiring a sample video frame sequence and sample labeling information, the sample labeling information being used to label a category of each sample pixel in the sample video frame sequence; determining a sample inter-frame feature and a sample intra-frame feature of the sample video frame sequence based on the sample video frame sequence and a to-be-trained model; determining initial sample category information for each sample pixel in the sample video frame sequence based on the sample inter-frame feature and the sample intra-frame feature; performing weighting on the initial sample category information to obtain a sample target category corresponding to each sample pixel in the sample video frame sequence; and adjusting parameters of the to-be-trained model based on the sample target category and the sample labeling information until the to-be-trained model converges, so as to obtain the preset category detection model after training.

12. The apparatus of claim 11, wherein determining initial sample category information for each sample pixel in the sample video frame sequence based on the sample inter-frame feature and the sample intra-frame feature comprises:
performing a convolution operation on the sample inter-frame feature and the sample intra-frame feature to obtain a sample convolution feature; and
determining the sample initial category information for each sample pixel in the sample video frame sequence based on the sample convolution feature.

13. The apparatus according to claim 8, wherein the target category comprises the to-be-repaired category and a normal category, and
determining a target category corresponding to each pixel in the to-be-repaired video frame sequence based on the to-be-repaired video frame sequence and a preset category detection model comprises:
inputting the to-be-repaired video frame sequence into the preset category detection model to obtain a probability graph, output by the preset category detection model, of each to-be-repaired video frame in the to-be-repaired video frame sequence, the probability graph being used to represent a probability that each pixel in each to-be-repaired video frame belongs to the to-be-repaired category; and
determining the target category corresponding to each pixel in the to-be-repaired video frame sequence based on the probability graph and a preset probability threshold.

14. The apparatus of claim 8, wherein the performing repairing on to-be-repaired areas corresponding to the to-be-repaired pixels to obtain a target video frame sequence comprises:
determining the to-be-repaired areas based on position information of the to-be-repaired pixels; and
performing repairing on the to-be-repaired areas based on preset repair software to obtain the target video frame sequence.

15. A non-transitory computer-readable storage medium storing computer instructions, wherein the computer instructions are used for causing a computer to execute operations comprising:.
acquiring a to-be-repaired video frame sequence;
determining a target category corresponding to each pixel in the to-be-repaired video frame sequence based on the to-be-repaired video frame sequence and a preset category detection model;
determining, from the to-be-repaired video frame sequence, to-be-repaired pixels each with a target category being a to-be-repaired category; and
performing repairing on to-be-repaired areas corresponding to the to-be-repaired pixels to obtain a target video frame sequence.

16. The non-transitory computer-readable storage medium of claim 15, wherein determining a target category corresponding to each pixel in the to-be-repaired video frame sequence based on the to-be-repaired video frame sequence and a preset category detection model comprises:
determining inter-frame feature information and intra-frame feature information of the to-be-repaired video frame sequence based on the to-be-repaired video frame sequence and the preset category detection model;
determining initial category information corresponding to each pixel in the to-be-repaired video frame sequence based on the inter-frame feature information and the intra-frame feature information; and
performing weighting on the initial category information to obtain the target category corresponding to each pixel in the to-be-repaired video frame sequence.

17. The non-transitory computer-readable storage medium of claim 16, wherein determining initial category information corresponding to each pixel in the to-be-repaired video frame sequence based on the inter-frame feature information and the intra-frame feature information comprises:
performing a convolution operation on the inter-frame feature information and the intra-frame feature information to obtain feature information after the convolution operation; and
determining the initial category information corresponding to each pixel in the to-be-repaired video frame sequence based on the feature information after the convolution operation.

18. The non-transitory computer-readable storage medium of claim 15, wherein the preset category detection model is trained by:
acquiring a sample video frame sequence and sample labeling information, the sample labeling information being used to label a category of each sample pixel in the sample video frame sequence;
determining a sample inter-frame feature and a sample intra-frame feature of the sample video frame sequence based on the sample video frame sequence and a to-be-trained model;
determining initial sample category information for each sample pixel in the sample video frame sequence based on the sample inter-frame feature and the sample intra-frame feature;
performing weighting on the initial sample category information to obtain a sample target category corresponding to each sample pixel in the sample video frame sequence; and
adjusting parameters of the to-be-trained model based on the sample target category and the sample labeling information until the to-be-trained model converges, so as to obtain the preset category detection model after training.

19. The non-transitory computer-readable storage medium of claim 18, wherein determining initial sample category information for each sample pixel in the sample video frame sequence based on the sample inter-frame feature and the sample intra-frame feature comprises:
performing a convolution operation on the sample inter-frame feature and the sample intra-frame feature to obtain a sample convolution feature; and
determining the sample initial category information for each sample pixel in the sample video frame sequence based on the sample convolution feature.

20. The non-transitory computer-readable storage medium of claim 15, wherein the target category comprises the to-be-repaired category and a normal category; and
determining a target category corresponding to each pixel in the to-be-repaired video frame sequence based on the to-be-repaired video frame sequence and a preset category detection model comprises:
inputting the to-be-repaired video frame sequence into the preset category detection model to obtain a probability graph, output by the preset category detection model, of each to-be-repaired video frame in the to-be-repaired video frame sequence, the probability graph being used to represent a probability that each pixel in each to-be-repaired video frame belongs to the to-be-repaired category; and
determining the target category corresponding to each pixel in the to-be-repaired video frame sequence based on the probability graph and a preset probability threshold.
